(19) United States
(12) Patent Application Publication
(10) Pub. No.: US 2026/0067249 A1
(43) Pub. Date: Mar. 5, 2026

(54) DUPLICATE ADDRESS DETECTION (DAD) RECOVERY

(71) Applicant: Arista Networks, Inc., Santa Clara, CA (US)

(72) Inventors: Akhil Shashidhar, Cedar Park, TX (US); Aaron David Bamberger, Austin, TX (US); Saurabh Singhal, Bangalore (IN); Dennis Sam, Vancouver (CA)

(21) Appl. No.: 18/825,329

(22) Filed: Sep. 5, 2024

(51) Int. Cl. H04L 61/5046; H04L 61/5069

(52) U.S. Cl. CPC H04L 61/5046; H04L 61/5069

(57) ABSTRACT

A method of operating a network device is provided that includes receiving, from another network device, a neighbor advertisement packet having a given address, disabling the given address by configuring the given address in a failed state in response to receiving the neighbor advertisement packet, and with a client running on the network device, sending a request to a duplicate address detection (DAD) restart manger executed on the network device to restart a duplicate address detection (DAD) process for the given address. The given address may be an Internet Protocol version 6 (IPv6) address.

### BACKGROUND

A communications system can include multiple network devices that are interconnected to form a network for conveying packets from a source device to a destination device. The network devices can communicate with one another using a IPv6 (Internet Protocol version 6) standard with an expanded address space.

An IPv6 address can be assigned to an interface of a network device. If that IPv6 address is already in use in the network, the network device attempting to assign that duplicate address will disable the IPv6 address on that interface. If care is not taken, however, certain interfaces can be inadvertently disabled, which can cause undesired network disruptions. It is within such context that the embodiments herein arise.

### BRIEF DESCRIPTION OF THE DRAWINGS

FIG. 1 is a diagram of an illustrative system having one or more network devices in accordance with some embodiments.

FIG. 2 is a diagram of an MLAG (multi-chassis link aggregation) switch pair being coupled to one or more host devices in accordance with some embodiments.

FIG. 3 is flowchart of illustrative steps for performing automatic DAD (duplicate address detection) recovery for the system shown in FIG. 2 in accordance with some embodiments.

FIG. 4 is a diagram showing how a DAD restart manager can receive DAD restart requests from one or more clients in accordance with some embodiments.

FIG. 5 is a flowchart of illustrative steps for performing automatic DAD recovery in response to a variety of client requests in accordance with some embodiments.

FIG. 6 is a diagram showing illustrative hardware components within a data processing system in accordance with some embodiments.

### DETAILED DESCRIPTION

A network device can include control circuitry, one or more packet processors, and associated input-output interfaces. The network device can be configured to support the IPv6 (Internet Protocol version 6) standard, which routes traffic across a network using IPv6 addresses. An IPv6 address can include 128 bits, which significantly expands the number of available IP addresses compared to IPv4 (version 4), which uses only 32-bit addresses.

The IPv6 standard can be provided with a Duplicate Address Detection (DAD) mechanism to ensure that no two devices on the same network have the same unicast IPv6 address. When an interface of a network device is assigned a unicast IPv6 address, the network device can send a neighbor solicitation (NS) packet with the assigned unicast IPv6 address and then listens for any responding neighbor advertisement (NA) packet(s) (e.g., to check whether any other device is already using the assigned unicast IPv6 address). If a neighbor advertisement packet for the same assigned unicast IPv6 address is received, then the network device determines that the address that is currently assigned to that interface is already in use on that network. As a result, the network device attempting to assign that duplicate address will disable the address on that interface, placing the address into a duplicate address error state or DAD failed state.

There are scenarios when an IPv6 address can be erroneously placed in the DAD failed state. In accordance with an embodiment, the network device can be provided with a DAD recovery (restart) manager configured to monitor for this erroneous DAD failed state. The DAD restart manager, in response to receiving a request from one or more software clients or agents running on the network device, can monitor specific addresses and interfaces and determine whether those addresses/interfaces are in an erroneous DAD failed state. After identifying an address being in an erroneous DAD failed state, the DAD restart manager can automatically restart the DAD process for that address without manual intervention. Operating a network device in this way can be technically advantageous and beneficial to provide automatic recovery of the DAD failed state on interfaces for addresses that are expected to be duplicated in the network and where possible race conditions can lead to erroneous disabling of an IPv6 address, with minimal disruption to the overall operation of the network.

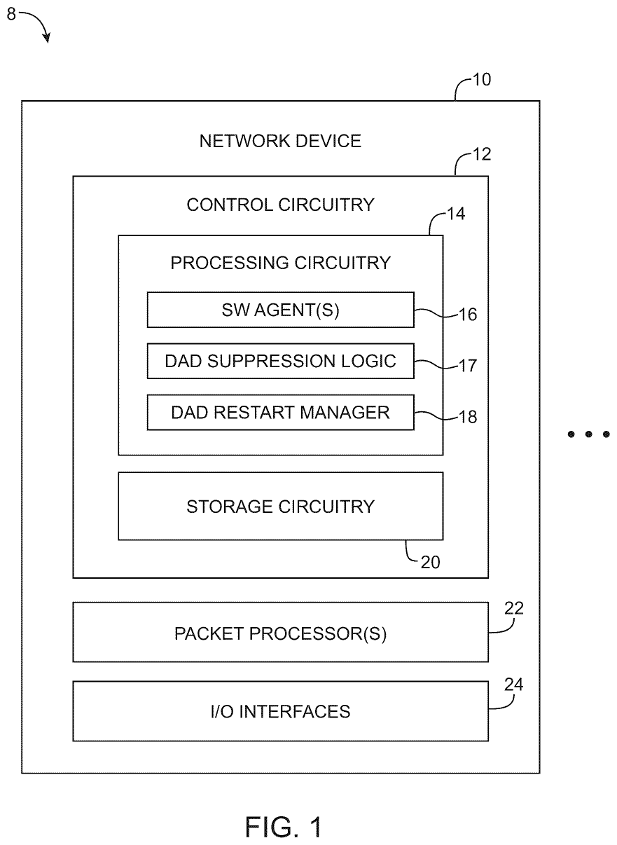

An illustrative network device such as network device 10 configured to provide DAD recovery capabilities is shown in FIG. 1. As shown in FIG. 1, a networking system 8 may include one or more network devices 10. Each network device 10 in system (network) 8 may be a network switch (e.g., a multi-layer L2/L3 switch), a router or gateway, a bridge, a hub, a repeater, a firewall, a wireless access point, a device serving other networking functions, a device that includes a combination of these functions, or other types of network devices. Multiple such network devices 10 having the same or different networking functions in system 8 may be present and interconnected to form a communications network that processes and/or forwards traffic (e.g., data packets) between end hosts.

The communications network may be implemented with any suitable scope (e.g., as a wide area network, including one or more campus area networks or including one or more local area networks, etc.). If desired, the communications network may include internet service provider networks (e.g., the Internet) or other public service provider networks, private service provider networks (e.g., multiprotocol label switching (MPLS) networks), and/or may include other types of networks such as telecommunication service provider networks (e.g., a long-term evolution (LTE) network).

As shown in FIG. 1, network device 10 may include control circuitry 12, one or more packet processor(s) 22, and input-output circuitry 24 disposed within a housing of network device 10. Control circuitry 12 may include processing circuitry 14 and storage circuitry 20. The housing of network device 10 may include an exterior cover (e.g., a plastic exterior shell, a metal exterior shell, or an exterior shell formed from other rigid or semirigid materials) that provides structural support and protection for the components of network device 10 disposed within the housing.

Processing circuitry 14 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other types of processors. Processing circuitry 14 may run (execute) a network device operating system and/or other software/firmware that is stored on storage circuitry 20.

Storage circuitry 20 may include non-transitory (tangible) computer readable storage media configured to store the operating system software and/or any other software code, sometimes referred to as program instructions, software, data, instructions, or code. As an example, the operations described herein for selectively delaying routes as well as other network device data plane functions may be stored as (software) instructions on the non-transitory computer-readable storage media (e.g., in portion(s) of storage circuitry 20 in network device 10). The corresponding processing circuitry (e.g., one or more processors of processing circuitry 14 in network device 10) may process or execute the respective instructions to perform the corresponding operations. Storage circuitry 20 may be implemented using non-volatile memory (e.g., flash memory or other electrically-programmable read-only memory configured to form a solid-state drive), volatile memory (e.g., static or dynamic random-access memory), hard disk drive storage, and/or other storage circuitry. Storage circuitry 20 is therefore sometimes referred to as memory circuitry. Processing circuitry 14 and memory circuitry 20 as described above may sometimes be referred to collectively as control circuitry 12 implementing a control plane of network device 10.

In particular, processing circuitry 14 may execute control plane software such as operating system software, routing policy management software, routing protocol agents or processes (e.g., software agents 16 being executed by processing circuitry 14), and/or other software, may be used to support the operation of protocol clients and/or servers, may be used to support the operation of packet processor(s) 22, may store packet forwarding information, may execute packet processing software, and/or may execute other software instructions that control the functions of network device 10 and the other components therein. As examples, the software agents 16 may implement Bidirectional Forwarding Detection (BFD) protocol, Address Resolution Protocol (ARP), Internet Group Management Protocol (IGMP), Link Aggregation Control Protocol (LACP), non-BGP distance vector routing protocols, Protocol Independent Multicast (PIM) protocols, Resource Reservation Protocol (RSVP), Link Layer Discovery Protocol (LLDP), Spanning Tree Protocol (STP), Virtual Extensible LAN (VXLAN) protocol, Two-Way Active Measurement Protocol (TWAMP), Precision Time Protocol (PTP), Connectivity Fault Management (CFM) protocol, Enhanced Interior Gateway Routing Protocol (EIGRP), Exterior Gateway Protocol (EGP), Routing Information Protocol (RIP), Open Shortest Path First (OSPF) protocol, Label Distribution Protocol (LDP), Multiprotocol Label Switching (MPLS), Intermediate System to Immediate System (IS-IS) protocol, or other Internet routing protocols (just to name a few).

Packet processor(s) 22 may be used to implement a data plane or forwarding plane of network device 10. Packet processor(s) 22 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other processor architectures.

Packet processor 22 may receive incoming data packets via input-output circuitry 24 (e.g., ports), parse and analyze the received data packets, process the packets based on packet forwarding decision data (e.g., in a forwarding information base) and/or in accordance with a network protocol, and forward (or drop) the data packet accordingly. The packet forwarding decision data may be stored on a portion of memory circuitry 20 and/or other storage circuitry integrated as part of or separate from packet processor 22. Input-output circuitry 24 may include communication interface components such as one or more Bluetooth interface, Wi-Fi interface, Ethernet interface, optical interface, and/or other wired or wireless network interfaces for connecting network device 10 to the Internet, a local area network, a wide area network, a mobile network, other types of networks, and/or to another network device, peripheral devices, and/or other electronic equipment. Network device 10 may also include other components such as a system bus or connector(s) that couple the components of network device 10 to one another, power management components, thermal management components, etc.

In accordance with an embodiment, processing circuitry 14 can be provided with an IPv6 duplicate address detection (“DAD”) feature configured to protect multiple devices 10 on a network from using the same unicast IPv6 address. When an interface of a device 10 is assigned a unicast IPv6 address, that device 10 can kickstart a DAD process by sending an ICMPv6 (Internet Control Message Protocol for IPv6) neighbor solicitation (NS) message with the assigned address as its own address and can then listen for any responding neighbor advertisement (NA) messages. The term “DAD process” can refer to and be defined herein as a process occurring at device 10 where device 10 sends a neighbor solicitation message/packet with an assigned address and then listens for any responding neighbor advertisement messages/packets having the same assigned address from other devices in the associated network. The neighbor solicitation messages and the neighbor advertisement messages can collectively be referred to and defined herein as DAD messages or DAD packets. If a neighbor advertisement message for the same assigned address is received, then device 10 can conclude that the address currently assigned is already in use on the network and can thus be considered a “duplicate” address. As a result, device 10 attempting to assign such duplicate address will disable that specific address on the interface, thus placing that address into a duplicate address error state or a DAD failed state, which ends the DAD process.

For example, there are certain scenarios where an IPv6 address can be expected to be duplicated in a network such as when using features that make use of anycast addresses. An “anycast” address is an IP address intended to be configured on multiple devices 10 in network 8, with the intention that a packet addressed to the anycast address can be handled identically by any of the devices 10 with the anycast address configured. There is no special anycast address range for IPv6. An anycast IPv6 address may be indistinguishable from a unicast address, except for its usage in the network. As a result, there is no way for device 10 to identify an address that is intended to be an anycast address from the address itself, rendering anycast addresses subject to duplicate address detection (DAD) the same way as any normal unicast address.

One example of the use of an IPv6 anycast address is when configuring an IPv6 address on an SVI (switch virtual interface), which can be used as the default gateway for attached host devices. Configuring an IPv6 on an SVI can occur when hosts move between different network devices. These hosts can be configured with the SVI anycast address as their default gateway, and the accompanying SVI on each device 10 that the host(s) may be able to move to can be configured with an identical anycast IP address. Operated in this way, a host can reach its default gateway with the same configured address no matter which network device 10 that host moves to. Because these anycast IP addresses are expected to be duplicated between different devices 10 on the same network, there needs to be some way of preventing the DAD feature from disabling all but one of the SVIs using the same anycast address. This can be accomplished via special forwarding rules that drop the neighbor solicitation messages (e.g., forwarding rules for dropping DAD packets) for these anycast addresses when they are configured. In the example of FIG. 1, network device 10 can be provided with a DAD suppression subsystem such as DAD suppression logic 17 configured to drop one or more DAD packets when the same IPv6 address is expected to be duplicated across multiple devices 10 in a network. The exact mechanism used to drop such packets can vary according to the type of interface, the type of packets being transmitted, the source of the duplicate address, and/or other factors.

In certain situations, there can be race conditions between when an anycast address is configured on an interface and when the special forwarding rules for dropping DAD packets for these anycast addresses are installed on a network device 10. In these situations, it is possible for the DAD packets to inadvertently leak out to one or more devices 10 on the network before the forwarding rules for dropping DAD packets are fully initialized, causing some of the interfaces with the anycast addresses configured to be disabled or placed in the failed state. Once this occurs, the only way to recover the interfaces is to manually unconfigure and reconfigure the IPv6 anycast address after the drop rules have been fully initialized, thereby clearing the failed state and restarting the DAD process.

In accordance with an embodiment, device 10 may be further provided with an automated mechanism that monitors for erroneous DAD failed states on specific interfaces and specific anycast address and automatically recovers a detected erroneous DAD failed state by restarting the DAD process on those specific interfaces/address without manual intervention. In the example of FIG. 1, device 10 can be provided with a DAD restart management subsystem such as a DAD restart manager 18. DAD restart manager 18 can represent a software component executed (running) on processing circuitry 14 or can be a hardware component included as part of processing circuitry 14. The DAD restart manager 18 can be configured to perform automatic targeted restart of a DAD process on one or more interfaces and for specific addresses that are expected to be duplicated in the network, which can be beneficial in situations where possible race conditions that can lead to erroneous disabling of an address due to DAD failures and can thus enable the recovery of such erroneously disabled addresses without affecting the overall DAD mechanism for addresses that are not expected to be duplicated. Restarting the DAD process can include sending a neighbor solicitation packet with one or more specific (assigned) addresses to other network devices and then monitoring for receipt of corresponding neighbor advertisement packet(s) having the specific/assigned address(es).

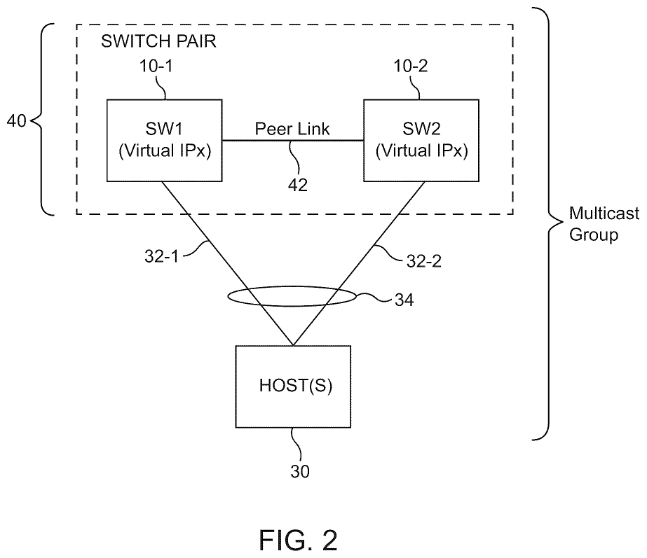

FIG. 2 is a diagram of an MLAG (multi-chassis link aggregation) switch pair such as MLAG switch pair 40 that includes a first network switch 10-1 and a second network switch 10-2. As shown in FIG. 2, the first network switch 10-1 can be communicatively coupled to the second network switch 10-2 via a peer link 42. Linked together in this way, the two physical switches 10-1 and 10-2 can be configured to operate as a single logic switch with the same virtual IP address (e.g., virtual address IPx). Operating MLAG switch pair 40 as a single logic switch using the MLAG technology can help provide increased bandwidth (e.g., by aggregating together the bandwidth of multiple physical links), additional redundancy (e.g., if one switch in the pair fails, then the other switch can continue to handle network traffic), improved load balancing (e.g., by distributing traffic across multiple physical links), and/or simplified network management.

In the example of FIG. 2, the MLAG switch pair 40 can be communicatively coupled to one or more host devices such as host(s) 30. For instance, a given host 30 can be physically coupled to the first network device (switch) 10-1 via a first communications path 32-1 and can simultaneously be coupled to the second network device (switch) 10-2 via a second communications path 32-2. When devices 10-1 and 10-2 are linked together as an MLAG switch pair 40 (e.g., when peer link 42 has been established), host 30 can be considered to be communicatively coupled to MLAG switch pair 40 via a single logical link 34. The one or more hosts 30 be communicatively coupled to MLAG switch pair 40 having the same virtual IP address shared between the two switches in pair 40 can all be collectively referred to herein as a multicast group.

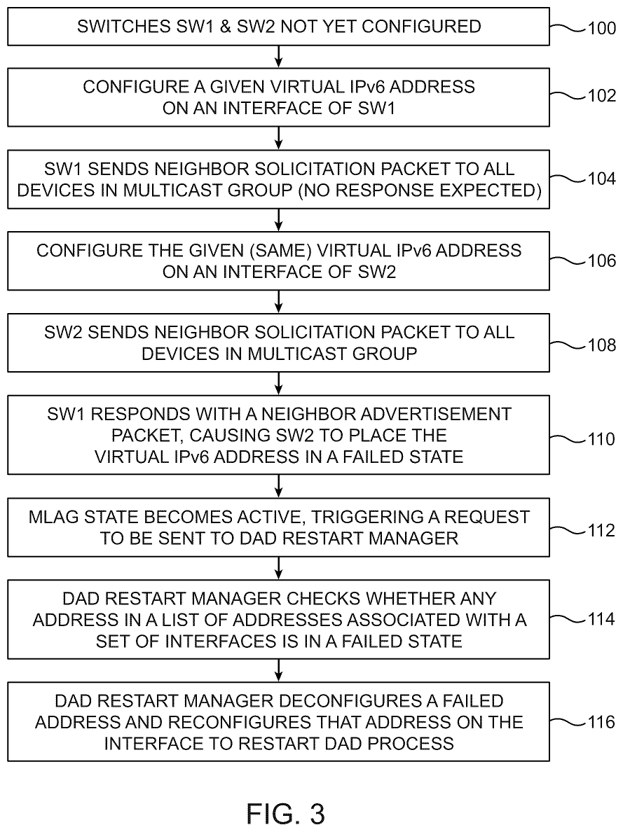

FIG. 3 is flowchart of illustrative steps for operating at least network devices (switches) 10-1 and 10-2 to perform automatic DAD (duplicate address detection) recovery for a multicast group of the type shown and described in connection with in FIG. 2. During the operations of block 100, a first network device such as first switch (SW1) 10-1 of FIG. 2 and a second network device such as second switch (SW2) 10-2 of FIG. 2 may not have yet been configured. Subsequently, during the operations of block 102, a given virtual IPv6 address can be configured on an interface of the first switch SW1.

The configuration of an address on the interface of switch SW1 can trigger switch SW1 to send a neighbor solicitation packet to all devices that are part of the same multicast group (see operations of block 104). The neighbor solicitation packet being transmitted by switch SW1 can include the target IPv6 address that is currently being assigned to switch SW1. Assuming that no other switches in the multicast group have been configured with an existing address (i.e., any address), switch SW1 should not be expecting a response to the neighbor solicitation packet.

During the operations of block 106, the given virtual IPv6 address (e.g., the same virtual IP address being used to configure switch SW1 during the operations of block 102) can be configured on an interface of the second switch SW2. The configuration of an address on the interface of switch SW2 can trigger switch SW2 to send a corresponding neighbor solicitation packet to all devices that are part of the same multicast group (see operations of block 108). The neighbor solicitation packet being transmitted by switch SW2 can include the target IPv6 address that is currently being assigned to switch SW2.

Here, since the IPv6 address currently being assigned to the second switch SW2 has already been configured at the first switch SW1, switch SW1 will respond with a neighbor advertisement packet that also includes the same target virtual IPv6 address (see operations of block 110). This neighbor advertisement packet can be received at switch SW2, which can cause switch SW2 to place the virtual IPv6 address in a failed state on its interface, sometimes referred to as a DAD failed state or a duplicate address error state. In general, switch SW2 (and/or switch SW1) can disable a specific address that has gone into the failed/error state instead of disabling the entire interface to avoid disrupting all other addresses configured on that interface.

Subsequently, during the operations of block 112, the MLAG state can become active. An “active” MLAG state can refer to the state of two switches being connected via an MLAG peer link (e.g., when two switches are now behaving as a single MLAG switch pair and jointly addressed by the same virtual IPv6 address). In other words, the operations of blocks 102-110 can be performed before an active MLAG state (e.g., blocks 102-110 are performed while the MLAG state is inactive). In accordance with an embodiment, when the MLAG state becomes active, each switch 10 in the MLAG switch pair can trigger or issue a request to be sent to its own DAD restart manager (see, e.g., DAD restart manager 18 of FIG. 1), as shown in the operations of block 112. In response to receiving such a trigger, the DAD restart manager 18 can check whether any addresses in a list of addresses associated with a set of interfaces are in a DAD failed state (see operations of block 114). Here, since switch SW1 was first to configure the given virtual IPv6 address, none of its addresses will be in a failed state.

Conversely, switch SW2 did previously place the target virtual IPv6 address in the failed state, as described above during the operations of block 110. Thus, during the operations of block 116, the DAD restart manager 18 of switch SW2 can deconfigure (delete) the failed address and then reconfigure (add back) the same address on the interface to restart the DAD process. Restarting the DAD process can include sending a neighbor solicitation packet with the target virtual IPv6 address and then monitoring/listening for any responding neighbor advertisement packet(s) having the same target (assigned) address from other switches in the network. Here, once the MLAG state is active, the DAD suppression logic 17 is now able to drop one or more DAD packets when the same IPv6 address is expected to be duplicated across multiple devices in the MLAG switch pair. Since the DAD suppression logic 17 will now filter or drop any responding neighbor advertisement packet(s) having the same IPv6 address that is expected to be duplicated across the MLAG switch pair, switch SW2 will no longer label that address as a duplicate address (e.g., switch SW2 will not place that address in the DAD failed state). If desired, the DAD suppression logic 17 on SW1 and SW2 can also filter or drop the initial neighbor solicitation packet transmitted by switch SW2.

Operating a multicast group in this way can be technically advantageous and beneficial to recover the DAD failed state on switch SW2 by automatically restarting the DAD process, which can be triggered by the MLAG state becoming active. DAD restart manager 18 can thus sometimes also be referred to as a DAD failed state recovery manager.

The operations of FIG. 3 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

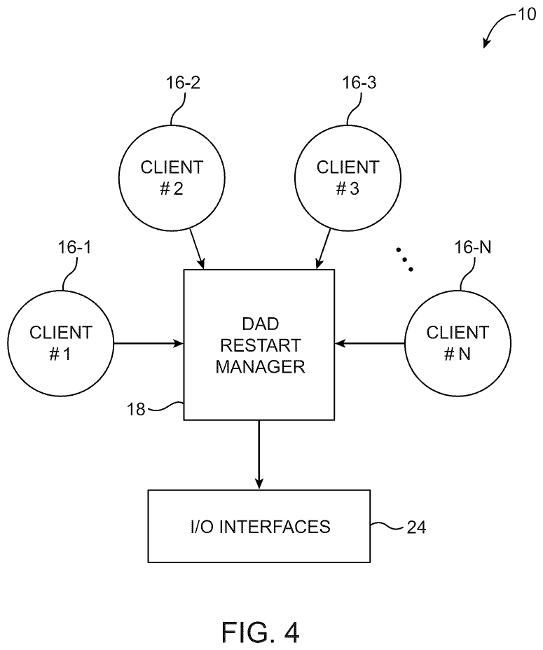

The example of FIGS. 2-3 in which automatic recovery of a DAD failed state is described in the context of an MLAG switch pair is illustrative. FIG. 4 is a diagram showing how a DAD restart manager 18 of a generic network device 10 can receive DAD restart requests from one or more clients in accordance with some embodiments. A DAD restart request can be a request to restart the DAD process for a specific IPv6 address. As shown in FIG. 4, the DAD restart manager 18 can be configured as a centralized component that responds to one or more client requests to keep certain interfaces/addresses from being stuck in the DAD failed/error state.

DAD restart manager 18 can be communicatively coupled to a first client 16-1 (e.g., a first software or hardware agent that is part of processing circuitry 14 of FIG. 1), a second client 16-2 (e.g., a second software or hardware agent on processing circuitry 14), a third client 16-3 (e.g., a third software or hardware agent on processing circuitry 14), . . . , and an N^{th} client 16-N (e.g., an N^{th} software or hardware agent on processing circuitry 14). Arranged in this way, DAD restart manager 18 can receive one or more client requests from each of client 16-1, client 16-2, client 16-3, . . . , and client 16-N. In general, the number N can represent an integer that is equal to two, two to five, five to ten, greater than ten, or other suitable integer value. DAD restart manager 18 can be coupled to input-output interfaces 24 to monitor one or more attributes associated with interfaces 24.

Configured in this way, DAD restart manager 18 can continuously monitor the state of any requested addresses associated with interfaces 24. When detecting that an address has erroneously entered a DAD failed state, the DAD restart manager 18 can deconfigure and then reconfigure the affected address to restart the DAD process with the goal of automatically recovering the address/interface from being disabled. The DAD restart manager 18 can be configured to only attempt recovery for an interface a set number of times and/or at specific restart/retry rates in order to avoid endlessly attempting recovery for an interface that is failing DAD due to reasons not due to transient race conditions.

The various clients 16 shown in FIG. 4 can be configured to monitor specific sources of potentially duplicate addresses. As an example, one of the clients can be configured to monitor for situations with potential race conditions, which can occur when the DAD packets are sent before the MLAG state becomes active, as described above in connection with FIGS. 2 and 3. As another example, one of the clients can be configured to monitor anycast addresses on switch virtual interfaces (SVIs). As another example, one of the clients can be configured to monitor a command line interface that is used to configure an interface of device 10. As another example, one of the clients can be a VXLAN (virtual extensible local area network) software forwarding agent configured to handle the encapsulation, decapsulation, and forward of VXLAN data packets. As another example, one of the clients can be an ARP (address resolution protocol) suppression agent configured to reduce the amount of broadcast traffic in a network by reducing ARP broadcasts. In general, these various client components 16 can make informed decisions on when to start requesting addresses to be kept out of the DAD failed state by sending a request or trigger to the DAD restart manager 18 to restart the DAD process.

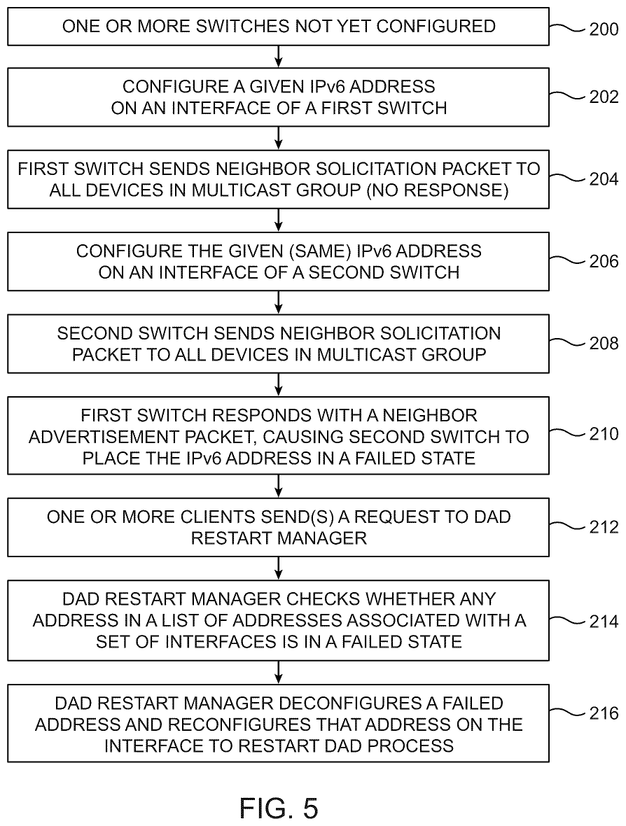

FIG. 5 is a flowchart of illustrative steps for operating one or more switches (e.g., one or more devices 10 described in connection with FIGS. 1-4) to perform automatic DAD recovery in response to a variety of client requests (triggers). Here, unlike the example of FIG. 3 where a request being sent to DAD restart manager 18 is triggered by the MLAG state becoming active, the request being sent to the DAD restart manager 18 can be triggered by any one of the various clients communicatively coupled to the DAD restart manager. During the operations of block 200, one or more switches in a network such as switch 10 of the type described in connection with FIG. 4 may not have yet been configured. Subsequently, during the operations of block 202, a given (target) virtual IPv6 address (e.g., an anycast address or a unicast address) can be configured on an interface of a first switch 10.

The configuration of an address on the interface of the first switch can trigger the first switch to send a neighbor solicitation packet to all devices that are part of the same multicast group (see operations of block 204). The neighbor solicitation packet being transmitted by the first switch can include the target IPv6 address that is currently being assigned to the first switch. Assuming that no other switches in the multicast group has been configured with an existing address (i.e., any address), the first switch should not be expecting a response to its neighbor solicitation packet.

During the operations of block 206, the given virtual IPv6 address (e.g., the same target IP address being used to configure the first switch during the operations of block 202) can be configured on an interface of a second switch 10 in the network. The configuration of an address on the interface of the second switch can trigger the second switch to send a corresponding neighbor solicitation packet to all devices that are part of the same multicast group (see operations of block 208). The neighbor solicitation packet being transmitted by the second switch can include the target IPv6 address that is currently being assigned to the second switch.

Here, since the IPv6 address currently being assigned to the second switch has already been configured at the first switch, the first switch will respond with a neighbor advertisement packet that also includes the same target virtual IPv6 address (see operations of block 210). This neighbor advertisement packet can be received at the second switch, which can cause the second switch to place the assigned virtual IPv6 address in a failed state on its interface, sometimes referred to as a DAD failed state or a duplicate address error state. The second switch 10 can disable a specific address that has gone into the failed/error state instead of disabling the entire interface to avoid disrupting all other addresses configured on that interface.

During the operations of block 212, one or more clients 16 can send a request to DAD restart manager 18 to trigger a restart of the DAD process. Such client requests can thus sometimes be referred to herein as a DAD restart request or a DAD state recovery request. In response to receiving such a client request, the DAD restart manager 18 can then check whether any addresses in a list of addresses associated with a set of interfaces of that device 10 are in a DAD failed state (see operations of block 214). Here, since the first switch was first to configure the given (target) virtual IPv6 address, none of its addresses will be in a failed state.

Conversely, the second switch did previously place the target virtual IPv6 address in the failed state, as described above during the operations of block 210. Thus, during the operations of block 216, the DAD restart manager 18 of the second switch can deconfigure (delete) the failed address and then reconfigure (add back) the same address on that interface to restart the DAD process. Restarting the DAD process at the second switch can include sending a neighbor solicitation packet with the target virtual IPv6 address and then monitoring/listening for any responding neighbor advertisement packet(s) having the same target (assigned) address from other switches in the network. Here, after at least the first and second switches have established a connection as being part of a multicast group or after the various clients are up and running on the second switch, the DAD suppression logic 17 on the second switch is now able to drop one or more DAD packets when the same IPv6 address is expected to be duplicated across multiple devices in the multicast group. Since the DAD suppression logic 17 will now filter or drop any responding neighbor advertisement packet(s) having the same IPv6 address that is expected to be duplicated across the multicast group, the second switch will no longer label that address as a duplicate address (e.g., the second switch will not place that address in the DAD failed state). If desired, the DAD suppression logic 17 on the first and/or second switches can also filter or drop the initial neighbor solicitation packet transmitted by the second switch. Operating a multicast group in this way can be technically advantageous and beneficial to recover the DAD failed state on the second switch by automatically restarting the DAD process, which can be triggered by a restart request received from any one of the various clients 16 running on the second switch.

The operations of FIG. 5 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

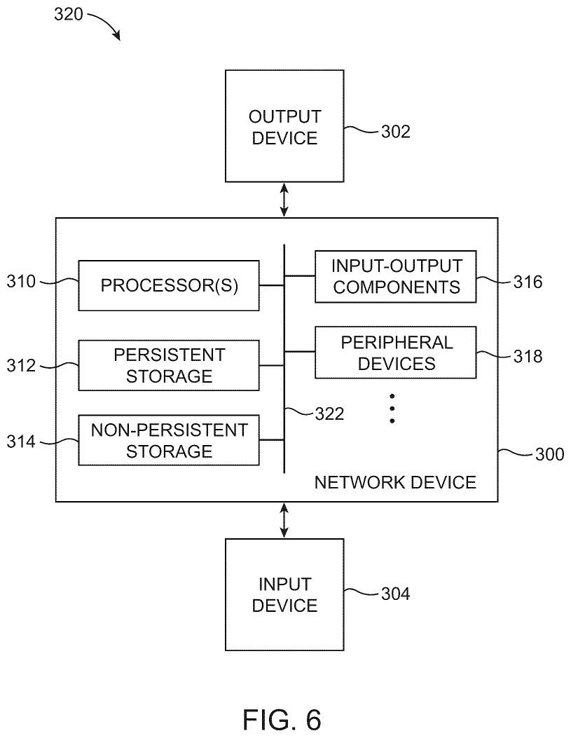

The foregoing embodiments may be made part of a larger system. FIG. 6 shows a system such as data processing system 320. Data processing system 320 may include a network device 300 optionally coupled to an input device 304 and/or an output device 302. Network device 300 may represent a network device 10 described in connection with the embodiments of FIGS. 1-5. Network device 300 may include one or more processors 310 (e.g., processing circuitry 14 of FIG. 1), storage circuitry such as persistent storage 312 (e.g., flash memory or other electrically-programmable read-only memory configured to form a solid-state drive, a hard disk drive, etc.), non-persistent storage 314 (e.g., volatile memory such as static or dynamic random-access memory, cache memory, etc.), or any suitable type of computer-readable media for storing data, software, program code, or instructions, input-output components 316 (e.g., communication interface components such as a Bluetooth® interface, a Wi-Fi® interface, an Ethernet interface, an optical interface, and/or other networking interfaces for connecting device 300 to the Internet, a local area network, a wide area network, a mobile network, other types of networks, and/or to another network device), peripheral devices 318, and/or other electronic components. These components can be coupled together via a system bus 322.

As an example, network device 300 can be part of a host device that is coupled to one or more output devices 302 and/or to one or more input devices 304. Input device(s) 304 may include one or more touchscreens, keyboards, mice, microphones, touchpads, electronic pens, joysticks, buttons, sensors, or any other type of input devices. Output device(s) 302 may include one or more displays, printers, speakers, status indicators, external storage, or any other type of output devices.

System 320 may be part of a digital system or a hybrid system that includes both digital and analog subsystems. System 320 may be used in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-6 may be performed by the components of one or more network device(s) using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., using processing circuitry 14 of FIG. 1).

The foregoing is merely illustrative and various modifications can be made to the described embodiments. The foregoing embodiments may be implemented individually or in any combination.

What is claimed is:

1. A method of operating a network device comprising:
receiving, from another network device, a neighbor advertisement packet having a given address, wherein an interface of the network device is configured with the given address;
in response to receiving the neighbor advertisement packet, disabling the given address on the interface by configuring the given address in a failed state; and
with a client running on the network device, sending a request to a duplicate address detection (DAD) restart manager executed on the network device to restart a duplicate address detection (DAD) process for the given address in the failed state.

2. The method of claim 1, further comprising:
before receiving the neighbor advertisement packet, configuring the given address on the interface; and
in response to configuring the given address on the interface and before receiving the neighbor advertisement packet, sending a neighbor solicitation packet having the given address to one or more network devices including the another network device.

3. The method of claim 2, wherein the network device and the one or more network devices are part of a same multicast group.

4. The method of claim 1, further comprising:
in response to receiving the request, determining, by the DAD restart manager, whether any address in a list of addresses is in the failed state.

5. The method of claim 4, further comprising:
in response to determining that at least one address in the list of addresses is in the failed state, deconfiguring the at least one address on the interface.

6. The method of claim 5, further comprising:
after deconfiguring the at least one address on the interface, reconfiguring the at least one address to restart the DAD process for the at least one address.

7. The method of claim 6, wherein the at least one address comprises the given address.

8. The method of claim 1, wherein the given address comprises an Internet Protocol version 6 (IPv6) address.

9. The method of claim 1, wherein the given address comprises an anycast address.

10. The method of claim 1, wherein restarting the DAD process for the given address comprises:
sending a neighbor solicitation packet having the given address to a plurality of network devices associated with the network device as being part of a same multicast group; and
monitoring for receipt of an additional neighbor advertisement packet having the given address.

11. The method of claim 10, further comprising:
with a duplicate address detection (DAD) suppression logic executed on the network device, dropping the neighbor solicitation packet or dropping the additional neighbor advertisement packet.

12. The method of claim 1, wherein the client comprises a software agent configured to monitor whether the network device has entered an active multi-chassis link aggregation (MLAG) state.

13. The method of claim 1, wherein the client comprises a software agent configured to monitor anycast addresses on switch virtual interfaces (SVIs) of the network device.

14. The method of claim 1, wherein the client comprises a software agent configured to monitor a command line interface of the network device.

15. The method of claim 1, wherein the client comprises a virtual extensible local area network (VXLAN) forwarding agent.

16. The method of claim 1, wherein the client comprises an address resolution protocol (ARP) suppression agent.

17. A method of operating a network device comprising:
configuring a virtual internet protocol (IP) address on an interface of the network device;
sending a neighbor solicitation packet having the virtual IP address to another network device;
receiving a neighbor advertisement packet having the virtual IP address from the another network device;
in response to receiving the neighbor advertisement packet, disabling the virtual IP address on the interface; and
in response to establishing an multi-chassis link aggregation (MLAG) peer link with the another network device, issuing a request to restart a duplication address detection (DAD) process.

18. The method of claim 17, further comprising:
in response to issuing the request to restart the DAD process, deconfiguring the virtual IP address and reconfiguring the virtual IP address on the interface.

19. The method of claim 17, further comprising:
in response to issuing the request to restart the DAD process, sending an additional neighbor solicitation packet having the virtual IP address to the another network device;
after sending the additional neighbor solicitation packet, monitoring for receipt of an additional neighbor advertisement packet having the virtual IP address; and
with a duplicate address detection (DAD) suppression logic running on the network device, dropping the additional neighbor solicitation packet or dropping the additional neighbor advertisement packet.

20. A network device comprising:
input-output interfaces;
a packet processor coupled to the input-output interfaces; and
control circuitry configured to:
monitor for receipt of a client request at a duplicate address detection (DAD) restart manager executed on the control circuitry; and
in response to detecting receipt of a client request, deconfiguring an address that is currently in a duplicate address error state on one of the input-output interfaces and reconfiguring the address.
